(19) United States
(12) Patent Application Publication
(10) Pub. No.: US 2007/0291903 A1
(43) Pub. Date: Dec. 20, 2007

(54) INTEGRAL X-RAY TUBE SHIELDING FOR HIGH-VOLTAGE X-RAY TUBE CABLES

(75) Inventor: Bradley D. Canfield, Orem, UT (US)

Correspondence Address: VARIAN MEDICAL SYSTEMS TECHNOLOGIES, INC.;C/O WORKMAN NYDEGGER, 60 E. SOUTH TEMPLE, SUITE 1000, SALT LAKE CITY, UT, 84111, US

(73) Assignee: VARIAN MEDICAL SYSTEMS TECHNOLOGIES, INC., Palo Alto, CA (US)

(21) Appl. No.: 11/424,439

(22) Filed: Jun. 15, 2006

(51) Int. Cl. H05G 1/06

(52) U.S. Cl. 378/194

(57) ABSTRACT

A shielded high-voltage cable connector assembly configured and arranged to control the unintended emission of x-rays from certain regions of an x-ray tube. The cable connector assembly includes a body comprising a material that is substantially non-transmissive to x-rays. The body is configured accommodate a plurality of conductive elements and position the plurality of conductive elements to interface with corresponding conductive elements of an x-ray device. The cable connector assembly can also include a connector housing filled with a material that is substantially non-transmissive to x-rays.

### BACKGROUND OF THE INVENTION

1. Field of the Invention

The present invention relates generally to x-ray systems, devices, and related components. More particularly, exemplary embodiments of the invention concern a shielded high-voltage cable connector assembly configured and arranged to control the unintended emission of x-rays from certain regions of an x-ray tube.

2. Related Technology

X-ray tubes are extremely valuable tools that are used in a wide variety of applications, both industrial and medical. An x-ray tube typically includes a cathode assembly and an anode assembly disposed within an evacuated enclosure. The cathode assembly includes an electron source and the anode assembly includes a target surface that is oriented to receive electrons emitted by the electron source. During operation of the x-ray tube, an electric current is applied to the electron source, which causes electrons to be produced by thermionic emission. The electrons are then accelerated toward the target surface of the anode assembly by applying a high-voltage potential between the cathode assembly and the anode assembly. When the electrons strike the anode assembly target surface, the kinetic energy of the electrons causes the production of x-rays. Some of the x-rays so produced ultimately exit the x-ray tube through a window in the x-ray tube, and interact with a material sample, patient, or other object.

Stationary anode x-ray tubes employ a stationary anode assembly that maintains the anode target surface stationary with respect to the stream of electrons produced by the cathode assembly electron source. In contrast, rotary anode x-ray tubes employ a rotary anode assembly that rotates portions of the anode's target surface into and out of the stream of electrons produced by the cathode assembly electron source. The target surfaces of both stationary and rotary anode x-ray tubes are generally angled, or otherwise oriented, so as to maximize the amount of x-rays produced at the target surface that can exit the x-ray tube via a window in the x-ray tube.

Notwithstanding the orientation of both stationary and rotary anode target surfaces, x-rays nonetheless emanate in various directions from the target surface. Thus, while some x-rays do exit through a window and are utilized as intended, some x-rays do not exit through the window. Some x-rays that do not pass through the window penetrate instead into other areas of the x-ray tube, where the x-rays may, undesirably, be transmitted through other x-ray tube surfaces if sufficient measures to prevent their escape are not taken.

The escape of unusable x-rays from an x-ray tube is undesired as such x-rays can represent a significant source of x-ray contamination to x-ray tube surroundings. For instance, such unused x-rays can result in transmission of a relatively high level of radiation to x-ray tube operators.

In addition, unused x-rays can interfere with the imaging x-ray stream that is transmitted through the x-ray tube window. Such interference may compromise the quality of the images obtained with the x-ray device. For example, unused x-rays can impinge upon areas of the x-ray subject and interfere with the image being sought. The resulting interference may be manifested as clouding in the image.

While the problem of x-ray leakage can be realized throughout the tube environment, certain areas of the x-ray tube are especially susceptible to the impingement of non-window transmitted x-rays. For example, the area of the x-ray tube where a high-voltage cable connector assembly attaches to the x-ray tube can be especially problematic. The area of the x-ray tube at which the cable connector assembly attaches is generally behind the cathode assembly of the x-ray tube. Since the electron source of the cathode assembly faces the target surface of the anode assembly, errant x-rays can emanate from the target surface toward the cathode assembly. Cathode assembly components are typically made of metals that are not effective at shielding x-rays, such as nickel or copper. X-rays typically pass through the cathode assembly without being blocked or absorbed, thus necessitating shielding materials behind the cathode assembly, either inside the x-ray tube or external to the x-ray tube.

In x-ray tubes where the high-voltage cable assembly attaches to the x-ray tube behind the cathode assembly, x-ray shielding material is often absent in order to facilitate the electrical connection between the x-ray tube and the high-voltage cable assembly. Instead, detachable shielding, made for example out of lead, is put in place after the high-voltage cable assembly has been connected to the x-ray tube. This detachable shielding can be problematic, however, because a user might neglect to install or replace the shielding after connecting the cable connector assembly. This potential neglect on the part of a user can lead to disastrous consequences in terms of radiation leakage from the x-ray tube.

Detachable x-ray shielding configured to attach behind a cable connector assembly can also be problematic for other reasons. For example, while such shielding can be effective at absorbing x-rays, when made of lead the shielding is relatively heavy and substantially adds to the weight of the x-ray tube. This factor becomes important in applications where a relatively low x-ray tube weight is desired or even required.

Another problem relates to the tendency of x-rays to spread out somewhat as the x-rays travel further away from the target surface. In particular, because the detachable shielding is often placed relatively far away from the target surface of the anode, relatively large amounts of shielding must be used to cover significant portions of the x-ray tube surface in order to account for the spreading of the x-rays. In some cases, nearly the entire surface area of the x-ray tube must be covered by a shielding material in order to prevent x-ray emission from the x-ray tube. The addition of x-ray shielding materials represents a significant cost in time and labor during x-ray tube manufacture.

In sum, there is an unmet need in the field of x-ray tubes to provide an x-ray tube structure that reduces the emission of errant x-rays, and that does so in a manner that minimizes the use of excessive, heavy internal or external shielding that significantly adds to the weight of the x-ray tube. Moreover, techniques for minimizing x-ray emissions in the region of an x-ray tube where a high-voltage cable connector assembly attaches would be especially attractive.

### BRIEF SUMMARY OF EXEMPLARY EMBODIMENTS OF THE INVENTION

Generally, embodiments of the invention concern a terminal and/or a connector housing of a high-voltage cable connector assembly. The terminal is constructed from a material that is substantially non-transmissive to x-rays in order to help prevent x-ray leakage from an x-ray tube to which it is operably attached. Likewise, the connector housing is filled with a material that is substantially non-transmissive to x-rays in order to help prevent x-ray leakage from an x-ray tube to which it is operably attached.

In one exemplary embodiment, the terminal includes a body comprising a material that is substantially non-transmissive to x-rays. In this embodiment, the body is configured to accommodate a plurality of conductive elements and position the plurality of conductive elements to interface with corresponding conductive elements of an x-ray device.

In another exemplary embodiment, the cable connector assembly includes a cable having one or more conductors, a connector housing within which a portion of the cable is disposed, and a terminal assembly attached to the fitting. In this embodiment, the terminal assembly includes a terminal comprising a material that is substantially non-transmissive to x-rays and has first and second ends. The first end is attached to the connector housing. The terminal assembly also includes one or more conductive elements that extend through the terminal from the first end to the second end. Each of the one or more conductive elements is electrically connected to a corresponding conductor of the cable and configured to interface with a corresponding conductive element of an x-ray device.

In yet another exemplary embodiment, the x-ray tube includes an outer housing comprising a material that is substantially non-transmissive to x-rays, an evacuated enclosure within the outer housing, an anode assembly disposed within the evacuated enclosure, a cathode assembly disposed within the evacuated enclosure and positioned to direct electrons to the anode assembly, one or more conductive elements electrically connected to the cathode, and a cable connector assembly. In this embodiment, the cable connector assembly includes a cable having one or more conductors, a connector housing within which a portion of the cable is disposed, and a terminal assembly attached to the connector housing. In this embodiment the terminal assembly includes a terminal substantially comprising a material that is substantially non-transmissive to x-rays and has first and second ends. The first end of the terminal is attached to the connector housing. The terminal assembly also includes one or more conductive pins that extend through the terminal from the first end to the second end. Each of the one or more conductive pins is electrically connected to a corresponding conductor of the cable and configured to interface with a corresponding conductive element of the x-ray tube.

In a final exemplary embodiment of the present invention, an x-ray tube includes an outer housing comprising a material that is substantially non-transmissive to x-rays, an evacuated enclosure within the outer housing, an anode assembly disposed within the evacuated enclosure, a cathode assembly disposed within the evacuated enclosure and positioned to direct electrons to the anode assembly, and an electrical cable assembly electrically connected to the cathode. In this embodiment, the electrical cable assembly includes a terminal that is made out of a material that is substantially non-transmissive to x-rays. Also in this embodiment, the outer housing defines an opening that is substantially transmissive to x-rays corresponding to a projected area defined by the terminal.

Embodiments of the invention provide for, among other things, shielding of x-rays in the area of an x-ray tube where a high-voltage cable connector assembly attaches to the x-ray tube. The shielding is integral to the cable connector assembly which helps avoid inadvertent removal of the shielding. These and other advantages and features will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a cross-sectional view of an x-ray tube utilizing one exemplary embodiment of the high-voltage cable connector assembly of the present invention;

FIGS. 2A and 2B are perspective views of the cable connector assembly of FIG. 1;

FIG. 3A is a side view of the cable connector assembly of FIG. 1;

FIGS. 3B and 3C are cross-sectional views of one section of the cable connector assembly of FIG. 3A;

FIG. 3D is another side view of the cable connector assembly of FIG. 1;

FIG. 3E is a cross-sectional view of one section of the cable connector assembly of FIG. 3D;

FIGS. 4A and 4B are perspective views of one exemplary embodiment of the terminal of the cable connector assembly of FIG. 1;

FIG. 4C is a top view of the terminal of FIGS. 4A and 4B; and

FIG. 4D is a cross-sectional view of one section of the terminal of FIG. 4C.

### DETAILED DESCRIPTION OF EXEMPLARY EMBODIMENTS OF THE INVENTION

Reference will now be made to the figures wherein like structures will be provided with like reference designations. It is understood that the drawings are diagrammatic and schematic representations of exemplary embodiments of the invention, and are not limiting of the present invention nor are they necessarily drawn to scale.

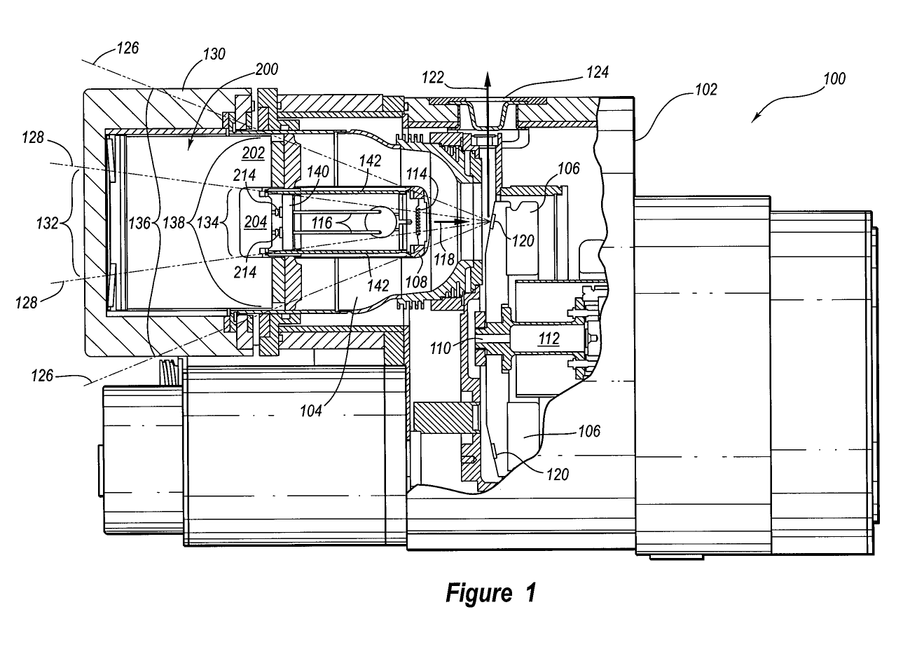

FIGS. 1-4D depict various features of embodiments of the present invention, which is generally directed to a high-voltage cable connector assembly having integral shielding for avoiding radiation leakage. The high-voltage cable connector assembly is utilized in connection with high-power x-ray devices, such as an x-ray tube. The present cable connector assembly enables an x-ray tube to require a minimal amount of shielding while controlling the incidence of radiation leakage through the area of the x-ray tube to which the cable connector assembly attaches. The present cable connector assembly also assures that essential shielding is in place during x-ray tube operation, thus avoiding x-ray leakage due to the intentional or negligent removal of essential shielding by users.

Reference is first made to FIG. 1, which illustrates in cross-section a simplified structure of an exemplary rotating anode-type x-ray tube 100 to which an exemplary embodiment of a high-voltage cable connector assembly 200 is attached. X-ray tube 100 includes an outer housing 102, within which is disposed an evacuated enclosure 104. Disposed within evacuated enclosure 104 are a rotating anode 106 and a cathode 108. Anode 106 is spaced apart from and oppositely disposed to cathode 108, and is at least partially composed of a thermally conductive material such as tungsten or a molybdenum alloy. Anode 106 is rotatably supported by a rotor shaft 110 and a bearing assembly 112.

As is typical, a high-voltage potential is provided between anode 106 and cathode 108. In the illustrated embodiment, cathode 108 is biased by a power source (not shown) to have a large negative voltage, while anode 106 is maintained at ground potential. In other embodiments, the cathode is biased with a negative voltage while the anode is biased with a positive voltage. X-ray tubes featuring either of these biasing configurations can utilize cable connector assembly 200. Also, while x-ray tube 100 features a rotating anode, it is appreciated that stationary anode x-ray tubes can also benefit from cable connector assembly 200 described herein.

Cathode 108 includes at least one filament 114 that is electrically connected to high-voltage cable connector assembly 200 through one or more conductive elements, illustrated in this embodiment as electrical leads 116. Electrical leads 116 are configured to connect with one or more conductive elements of cable connector assembly 200, illustrated in this embodiment as electrically conductive pins 214. Each of pins 214, in turn, connects to a conductor of a high-voltage cable, as shown in later figures. The high-voltage cable is, in turn, connected to a high-voltage power source (not shown). Cable connector assembly 200, via the high-voltage cable, the conductors within the cable, pins 214, and electrical lead 116, facilitates the provision of an electrical voltage bias to cathode 108, as well as an electric current to the filament 114 during x-ray tube operation. As such, cable connector assembly 200 couples electrical components of cathode 108 with the high-voltage cable. During operation, electrical current is passed through the filament 114 to cause electrons, designated at 118, to be emitted from cathode 108 by thermionic emission. Application of the high-voltage differential between anode 106 and cathode 108 then causes electrons 118 to accelerate from cathode filament 114 toward a focal track 120 that is positioned on a target surface of rotating anode 106. Focal track 120 is typically composed of tungsten or a similar material having a high atomic (“high Z”) number.

As electrons 118 accelerate, they gain a substantial amount of kinetic energy, and upon striking the target material on focal track 120, some of this kinetic energy is converted into electromagnetic waves of very high frequency, i.e., x-rays. At least some of the emitted x-rays, designated at 122, are directed through x-ray transmissive window 124 disposed in outer housing 102. Window 124 is comprised of an x-ray transmissive material so as to enable the x-rays to pass through window 124 and exit x-ray tube 100. The x-rays exiting the tube 100 can then be directed for penetration into an object, such as a patient's body during a medical evaluation, or a sample for purposes of materials analysis.

Other x-rays, however, emanate in undesired directions and, accordingly, are of no practical use. Some of these unusable x-rays emanate into focal track 120 or other portions of anode 106. These x-rays are absorbed and generally are not problematic insofar as x-ray device operators and other personnel and equipment in the surrounding area are concerned. As indicated in FIG. 1, however, yet other x-rays emanate from focal track 120 in a generally conical x-ray pattern 126 that is at least partially intercepted by a connector housing 202 of the cable connector assembly 200. Likewise, a subset of this generally conical x-ray pattern 126, designated as a generally conical x-ray pattern 128, is also at least partially intercepted by a terminal 204 of the cable connector assembly 200.

Where, as discussed further below, terminal 204 is made from a material that is substantially non-transmissive to x-rays, terminal 204 functions as an x-ray shield for the x-rays in pattern 128 when operably connected to x-ray tube 100. Likewise, where, as also discussed further below, connector housing 202 is filled with a material that is substantially non-transmissive to x-rays, connector housing 202 functions as an x-ray shield for the x-rays in pattern 126. Absent making connector housing 202 and/or terminal 204 out of a material that is substantially non-transmissive to x-rays, it is necessary to provide x-ray shielding in order to shield the x-rays in patterns 128 and 126. This shielding can be provided by detachable shielding 130. However, constructing detachable shielding 130 out of a material substantially non-transmissive to x-rays is problematic. As can be seen from the expanding patterns 126 and 128, since detachable shielding 130 is further from anode 106 than terminal 204 is from anode 106, a larger area 132 of shielding material is required for detachable shielding 130 than the area 134 of shielding required when terminal 204 is made from shielding material. Likewise, since detachable shielding 130 is further from anode 106 than connector housing 202 is from anode 106, a larger area 136 of shielding material is required for detachable shielding 130 than the area 138 of shielding required when connector housing 202 is made from shielding material.

Where terminal 204 is formed out of a conductive x-ray shielding material, such as brass, terminal 204 can be configured to function as a Faraday Cage with respect to the electrical connection between pins 214 and the corresponding electrical leads 116. A Faraday Cage is an equi-potential region in a high voltage field, created in this case to allow feeding electricity into the x-ray tube and prevent ionization of any air captured in the interface volume between cable connector assembly 200 and the x-ray tube 100. This interface volume is defined by an evacuated enclosure seal 140, an inner cathode housing 142, and terminal 204. The Faraday Cage removes the need to fill the interface volume with oil or create a vacuum in the interface volume in order to avoid the ionization of air trapped in the interface volume.

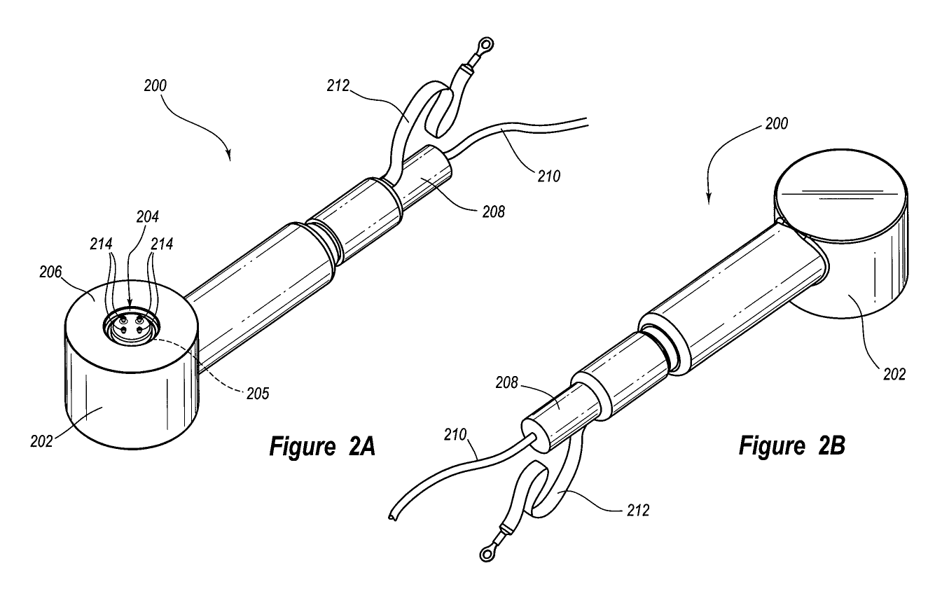

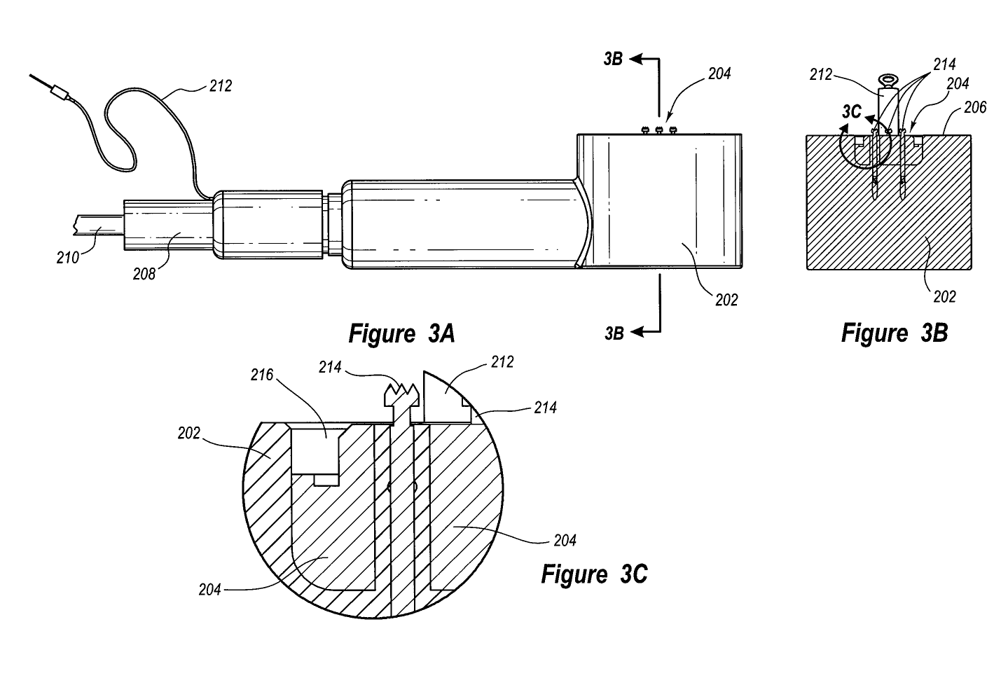

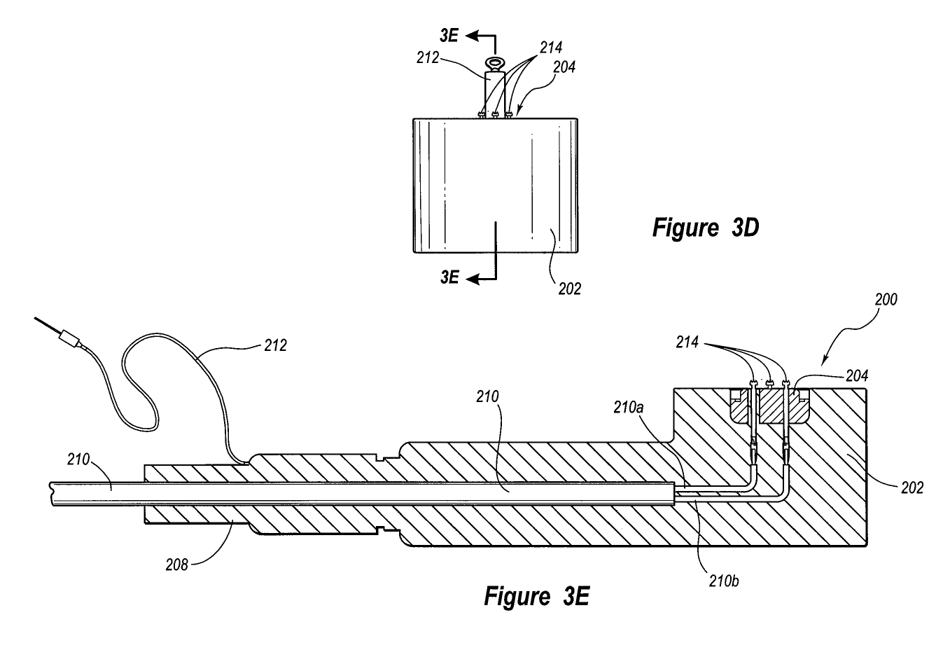

Reference is now made to FIGS. 2A and 2B, which show perspective views of high-voltage cable connector assembly 200. Cable connector assembly 200, as described briefly in connection with FIG. 1, generally includes the connector housing 202 and terminal 204. Connector housing 202, in addition to housing the other components of the cable connector assembly 200, provides a mounting surface 206 for attaching cable connector assembly 200 to x-ray tube 100 via mechanical fasteners or other appropriate mode of attachment. Connector housing 202 further defines a port 208 through which a high-voltage cable 210 passes. High-voltage cable 210 includes one or more conductors, as discussed and illustrated below in connection with FIG. 3E.

As illustrated in FIG. 2A, terminal 204 is disposed within a cavity 205 defined by connector housing 202. Terminal 204 is centrally positioned on mounting surface 206 of connector housing 202 so as facilitate electrical connection with corresponding components of x-ray tube 100. Connector housing 202 is generally formed from an insulating material that provides electrical isolation of connector housing 202 from terminal 204. The insulating material, in one embodiment, comprises an insulating epoxy.

Cable connector assembly 200 also includes cable ground lead 212, which is used to provide a ground for the components of cable connector assembly 200. Cable connector assembly 200 also includes one or more conductive elements, which are illustrated as electrically conductive pins 214. Each of pins 214 is electrically connected within connector housing 202 to a corresponding conductor within high-voltage cable 210, as discussed and illustrated below in connection with FIG. 3E.

FIG. 3A is a side view of high-voltage cable connector assembly 200. The line 3B in FIG. 3A defines the location of the cross-sectional view illustrated in FIG. 3B. As shown in FIG. 3B, terminal 204 is disposed within connector housing 202 so that the outer surface of terminal 204 is substantially flush with the mounting surface 206 of connector housing 202. Likewise, various conductive elements, which are illustrated here as electrical pins 214, extend through terminal 204 into connector housing 202 where they are electrically connected to corresponding conductors within high-voltage cable 210, as illustrated below in connection with FIG. 3E. These electrical pins 214 are positioned and configured to interface with corresponding electrical leads 116 of x-ray device 100, which in turn interface with the filament 114 of cathode 108, as illustrated in FIG. 1.

As illustrated in FIG. 3A, terminal 204 in this exemplary embodiment is made from a material that is substantially non-transmissive to x-rays. This material can be any type of x-ray shielding material, such as, for example, a high Z material. Some suitable exemplary materials from which to form terminal 204 include at least one of brass, tungsten, tantalum, niobium, or lead. Since terminal 204 is made from a material that is substantially non-transmissive to x-rays, terminal 204 functions as an x-ray shield with respect a projected area defined by terminal 204, illustrated in FIG. 1 as area 134 of x-ray pattern 128, when cable connector assembly 200 is operably connected to x-ray tube 100. The term “projected area defined by the terminal” herein refers to the area of the outer housing of the x-ray tube that does not require shielding due to shielding integral to the terminal.

Connector housing 202, as discussed above, is formed from an insulating epoxy, such as a thermosetting plastic material. In order to maintain dialectic properties as well as provide x-ray shielding, this plastic can be filled with at least one x-ray attenuating material, or in other words, a material that is substantially non-transmissive to x-rays. This material can be any type of x-ray shielding material, such as, for example, a high Z material. Some suitable exemplary materials which can fill connector housing 202 include at least one of bismuth oxide, barium sulfate, or lead oxide. Since connector housing 202 is filled with a material that is substantially non-transmissive to x-rays, connector housing 202 functions as an x-ray shield with respect to a projected area defined by connector housing 202, illustrated in FIG. 1 as area 138 of x-ray pattern 126, when cable connector assembly 200 is operably connected to x-ray tube 100. The “projected area defined by the connector housing” herein refers to the area of the outer housing of the x-ray tube that does not require shielding due to shielding integral to the connector housing.

FIG. 3C illustrates a magnified view of the area labeled 3C of FIG. 3B. A cylindrically shaped, annular gap 216 is defined between connector housing 202 and terminal 204. The gap 216 is configured to receive therein a portion of inner cathode housing 142, as illustrated in FIG. 1. The configuration of the gap 216, in combination with the fact that terminal 204 is made from a metal material that is substantially non-transmissive to x-rays, such as brass, allows terminal 204 to function as a Faraday Cage, as discussed above, with respect to the electrical connection between pins 214 and electrical leads 116 of the x-ray device 100 when cable connection assembly 200 is operably connected to x-ray tube 100.

FIG. 3D is another side view of high-voltage cable connector assembly 200. The line 3E in FIG. 3D defines the location of the cross-sectional view of cable connector assembly 200 illustrated in FIG. 3E. FIG. 3E illustrates the portion of high-voltage cable 210 that is disposed within connector housing 202. FIG. 3E also illustrates that each of pins 214 is electrically connected within connector housing 202 to a corresponding conductor within high-voltage cable 210, illustrated here as conductors 210a and 210b. Conductors within cable 210, such as conductors 210a and 210b, enable electrical power to be delivered through cable 210 to pins 214.

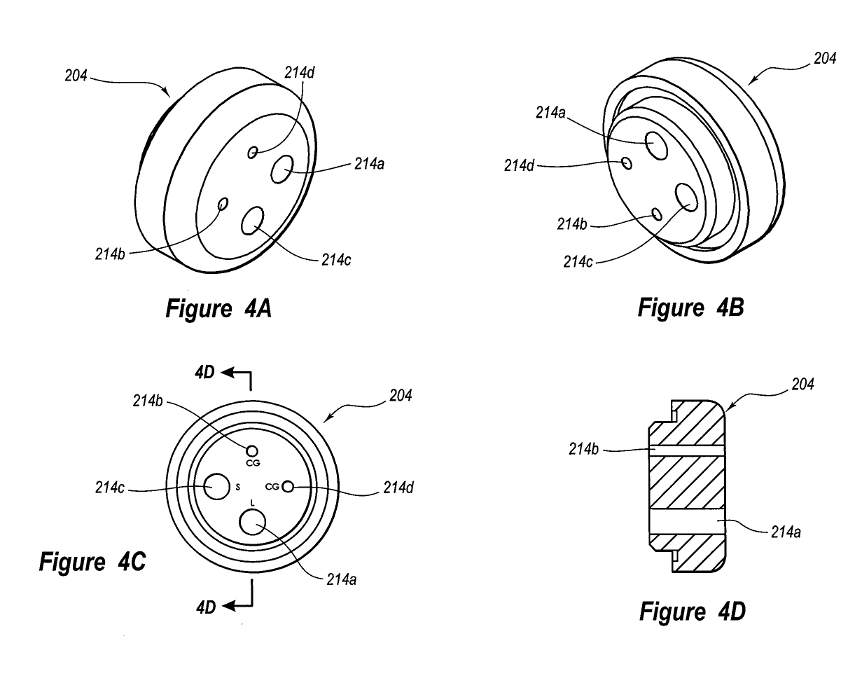

FIGS. 4A-4D illustrate in greater detail terminal 204 described above. FIG. 4A illustrates a bottom perspective view of terminal 204 where four holes 214a-214d through which pins 214 can be inserted when cable connector assembly 200 is assembled. FIG. 4B illustrates a top perspective view of terminal 204, which also illustrates the four holes 214a-214d through which pins 214 can be inserted. FIG. 4C illustrates a top view of terminal 204. FIG. 4C illustrates a representative label next to each of holes 214a-214d. The label ‘L’ represent “Large Filament,” the label ‘S’ represents “Small Filament,” and the label ‘CG’ represents “Common/Grid.” These labels identify the type of pin 214 and/or type of electrical connection associated with each of holes 214a-214d. This arrangement is exemplary, and other possible arrangements with differing numbers of holes are contemplated.

FIG. 4D illustrates a cross-sectional view of terminal 204 defined by the line 4D in FIG. 4C. FIG. 4D illustrates that the holes passing through terminal 204 can have different diameters with respect to each other. For example, hole 214a is illustrated as having a diameter that is roughly twice the diameter of hole 214b. Although it is conceivable that a minimal number of x-rays can pass through holes 214a-214d of terminal 204, the thickness of terminal 204 can be configured such that the likelihood that an x-ray traveling in a generally linear course will pass through one of these holes without coming in contact with terminal 204 is extremely small. Therefore, even with holes 214a-214d, terminal 204 can substantially block all x-rays from passing through terminal 204. Additionally, where connector housing 202 is filled with a material that is substantially non-transmissive to x-rays, any x-rays passing through holes 214a-214d will be blocked by connector housing 202.

At least one advantage of the x-ray shielding properties of terminal 204 is that terminal 204 is integral to cable connection assembly 200. In order for x-ray tube 100 to function and produce x-rays, cable connection assembly 200 must be operably connected to x-ray tube 100. Since x-ray shielding is integrated into terminal 204 of cable connection assembly 200, x-ray tube 100 will not function unless the x-ray shielding integrated into terminal 204 is in place. Likewise, where x-ray shielding is integrated into connector housing 202 of cable connection assembly 200, x-ray tube 100 will not function unless the x-ray shielding integrated into connector housing 202 is in place. Unlike detachable shielding configured to surround cable connector assembly 200, the shielding integrated into terminal 204 or connector housing 202 can not be inadvertently missing during the operation of x-ray tube 100.

The disclosed embodiments are to be considered in all respects only as exemplary and not restrictive. The scope of the invention is, therefore, indicated by the appended claims rather than by the foregoing disclosure. All changes which come within the meaning and range of equivalency of the claims are to be embraced within their scope.

What is claimed is:

1. A terminal, comprising:
a body comprising a material that is substantially non-transmissive to x-rays, the body being configured to:
accommodate a plurality of conductive elements; and
position the plurality of conductive elements to interface with corresponding conductive elements of an x-ray device.

2. The terminal as recited in claim 1, wherein the material that is substantially non-transmissive to x-rays comprises a high Z material.

3. The terminal as recited in claim 1, wherein the material that is substantially non-transmissive to x-rays comprises at least one of brass, tungsten, tantalum, niobium, or lead.

4. A cable connector assembly comprising:
a cable having one or more conductors;
a connector housing within which a portion of the cable is disposed; and
a terminal assembly attached to the fitting, the terminal assembly comprising:
a terminal comprising a material that is substantially non-transmissive to x-rays and having first and second ends, the first end being attached to the connector housing; and
one or more conductive elements that extend through the terminal from the first end to the second end, each of the one or more conductive elements being electrically connected to a corresponding conductor of the cable and configured to interface with a corresponding conductive element of an x-ray device.

5. The cable connector assembly as recited in claim 4, wherein the material that is substantially non-transmissive to x-rays comprises a high Z material.

6. The cable connector assembly as recited in claim 4, wherein the material that is substantially non-transmissive to x-rays comprises at least one of brass, tungsten, tantalum, niobium, or lead.

7. The cable connector assembly as recited in claim 4, wherein the connector housing comprises a thermosetting plastic material.

8. The cable connector assembly as recited in claim 7, wherein the thermosetting plastic material is filled with a material that is substantially non-transmissive to x-rays.

9. The cable connector assembly as recited in claim 8, wherein the thermosetting plastic material is filled with at least one of bismuth oxide, barium sulfate, or lead oxide.

10. The cable connector assembly as recited in claim 4, wherein the terminal comprises a Faraday Cage with respect to the electrical connection between the one or more conductive elements and the corresponding conductive elements of the x-ray device.

11. The cable connector assembly as recited in claim 4, wherein the cable connector assembly is configured to releasably engage an electrical connection of the x-ray device.

12. An x-ray tube comprising:
an outer housing comprising a material that is substantially non-transmissive to x-rays;
an evacuated enclosure within the outer housing;
an anode assembly disposed within the evacuated enclosure;
a cathode assembly disposed within the evacuated enclosure and positioned to direct electrons to the anode assembly;
one or more conductive elements electrically connected to the cathode; and
a cable connector assembly comprising:
a cable having one or more conductors;
a connector housing within which a portion of the cable is disposed; and
a terminal assembly attached to the connector housing, the terminal assembly comprising:
a terminal substantially comprising a material that is substantially non-transmissive to x-rays and having first and second ends, the first end being attached to the connector housing; and
one or more conductive pins that extend through the terminal from the first end to the second end, each of the one or more conductive pins being electrically connected to a corresponding conductor of the cable and configured to interface with a corresponding conductive element of the x-ray tube.

13. The x-ray tube as recited in claim 12, wherein the material that is substantially non-transmissive to x-rays comprises a high Z material.

14. The x-ray tube as recited in claim 12, wherein the material that is substantially non-transmissive to x-rays comprises at least one of brass, tungsten, tantalum, niobium, or lead.

15. The x-ray tube as recited in claim 12, wherein the connector housing comprises a thermosetting plastic material.

16. The x-ray tube as recited in claim 15, wherein the thermosetting plastic material is filled with a material that is substantially non-transmissive to x-rays.

17. The x-ray tube as recited in claim 16, wherein the thermosetting plastic material is filled with at least one of bismuth oxide, barium sulfate, or lead oxide.

18. The x-ray tube as recited in claim 16, wherein the outer housing defines an opening that is substantially transmissive to x-rays corresponding to a projected area defined by the connector housing.

19. The x-ray tube as recited in claim 12, wherein the terminal comprises a Faraday Cage with respect to the electrical connection between the one or more conductive pins and the corresponding conductive elements of the x-ray tube.

20. The x-ray tube as recited in claim 11, wherein the outer housing defines an opening that is substantially transmissive to x-rays corresponding to a projected area defined by the terminal.

21. An x-ray tube comprising:
an outer housing comprising a material that is substantially non-transmissive to x-rays;
an evacuated enclosure within the outer housing;
an anode assembly disposed within the evacuated enclosure;
a cathode assembly disposed within the evacuated enclosure and positioned to direct electrons to the anode assembly; and
an cable connector assembly electrically connected to the cathode, the electrical cable assembly comprising:
a terminal comprising a material that is substantially non-transmissive to x-rays;
wherein the outer housing defines an opening that is substantially transmissive to x-rays corresponding to a projected area defined by the terminal.
